(19) United States
(12) Patent Application Publication
(10) Pub. No.: US 2010/0092843 A1
(43) Pub. Date: Apr. 15, 2010

(54) VENTURI PUMPING SYSTEM IN A HYDROGEN GAS CIRCULATION OF A FLOW BATTERY

(75) Inventor: Bruce Conway, La Honda, CA (US)

Correspondence Address: HAYNES AND BOONE, LLP;IP Section, 2323 Victory Avenue, Suite 700, Dallas, TX, 75219, US

(73) Assignee: Deeya Energy Technologies, Inc.

(21) Appl. No.: 12/576,240

(22) Filed: Oct. 8, 2009

Related U.S. Application Data
(60) Provisional application No. 61/104,596, filed on Oct. 10, 2008.

(51) Int. Cl. H01M 2/38; H01M 2/36

(52) U.S. Cl. 429/51; 429/72

(57) ABSTRACT

A redox flow battery system is presented that utilizes a rebalancing cell. A pump based on the Venturi principle is coupled to the rebalancing cell in order to actively circulate hydrogen gas through the rebalancing cell. The venturi pump requires no moving parts which eliminates problems of reliability and cost. Utilizing the venturi pump to actively circulate gas can significantly enhanced the function of the rebalance cell thereby providing enhanced capacity and performance of the flow battery system.

### CROSS-REFERENCE TO RELATED APPLICATIONS

The present application claims benefit under 35 U.S.C. §119(e) of U.S. Provisional Application No. 61/104,596 filed on Oct. 10, 2008, entitled “Venturi Pumping System In A Hydrogen Gas Circulation Of A Flow Battery,” the content of which is hereby incorporated by reference in its entirety.

### BACKGROUND

1. Technical Field

This invention relates to battery systems, and more specifically, to reduction-oxidation (redox) flow batteries with a hydrogen rebalance cell.

2. Discussion of Related Art

Redox flow batteries store electrical energy in a chemical form and subsequently dispense the stored energy in an electrical form via a spontaneous reverse redox reaction. Conversion between chemical and electrical energy occurs in a reactor cell.

Electrolyte can be flowed through a reactor cell where the electrochemical reaction takes place. Externally stored electrolytes can be flowed through the battery system by pumping, gravity feed, or by any other method of moving fluid through the system. The electrolyte can be charged and discharged through many cycles. However, over time the electrolyte degrades, at least partially as a result of loss of hydrogen from the electrolyte. Hydrogen gas is emitted as a byproduct of the electrochemical charge and discharge reactions that the electrolyte undergoes.

Redox flow batteries have a wide application. Examples include use as uninterruptible power supplies for mission critical devices and services, storage and distribution of green energy, and electric automobiles.

There is, therefore, a need to provide an efficient and simplified way to maintain balance of the electrolyte and enhance overall capacity, lifetime, and performance of the battery system.

### SUMMARY

Consistent with embodiments of the present invention, a redox flow cell system having a rebalance cell and a venturi pump, and providing enhanced capacity and performance of the flow battery is presented.

A redox flow cell system according to the present invention can include at least one flow cell; a pumping system that pumps a first electrolyte from a first storage tank through a first half cell of the at least one flow cell; a rebalance cell coupled to receive a second electrolyte from a second storage tank; and a venturi pump in the pumping system, the venturi pump further coupled to receive gasses that flow from the first storage tank and through the rebalance cell.

A method for circulating hydrogen gas in a redox flow cell system consistent with embodiments of the present invention includes flowing a first electrolyte via a pumping system from a first storage tank through a first half cell of at least one flow cell; receiving a second electrolyte into a rebalance cell coupled to receive the second electrolyte; and drawing hydrogen gas from the first storage tank through the rebalance cell using a venturi pump coupled to the pumping system and further coupled to draw hydrogen gas from the first storage tank through the rebalance cell.

A method of rebalancing a redox flow cell system consistent with embodiments of the present invention includes flowing a first electrolyte via a pumping system from a first storage tank through a first half cell of at least one flow cell; receiving a second electrolyte into a rebalance cell coupled to receive the second electrolyte; and drawing hydrogen gas from the first storage tank through the rebalance cell using a venturi pump coupled to the pumping system and further coupled to draw hydrogen gas from the first storage tank through the rebalance cell.

These and other embodiments of the present invention are further described below with reference to the following figures.

### BRIEF DESCRIPTION OF THE DRAWINGS

In order to more fully understand the present invention, reference is made to the accompanying drawings, with the understanding that these drawings are not intended to limit the scope of the invention.

FIG. 1 is graphical representation of an exemplary redox flow battery system.

FIG. 2 is a block diagram which shows incorporation of a venturi pump within a redox flow battery system consistent with some embodiments of the present invention.

FIG. 3 is a detailed graphical representation of a venturi pump consistent with some embodiments of the present invention.

In the figures, elements having the same designation have the same or similar function. The figures are illustrative only and relative sizes and distances depicted in the figures are for convenience of illustration only and have no further meaning.

### DETAILED DESCRIPTION

This description is explicative of certain embodiments of the invention and should not be considered to be limiting. The apparatus components and method steps are represented here by appropriate conventional symbols in the drawings, showing only those specific details that are pertinent to understanding the embodiments of the present invention so as not to obscure the disclosure with details that will be readily apparent to those of ordinary skill in the art having the benefit of the description herein.

Consistent with the embodiments of the present invention, a reduction-oxidation (redox) flow battery with active hydrogen circulation without the need for any externally powered pump is proposed.

A redox flow battery according to the present invention can include a simple, no moving parts pump, based on the Venturi principle. The pump may be fitted to an electrolyte return line and employed to circulate hydrogen gas using reverse suction.

A method of providing active hydrogen circulation consistent with embodiments of the present invention includes enhanced performance of the rebalance cell by providing a suitable transfer of hydrogen into the rebalance cell.

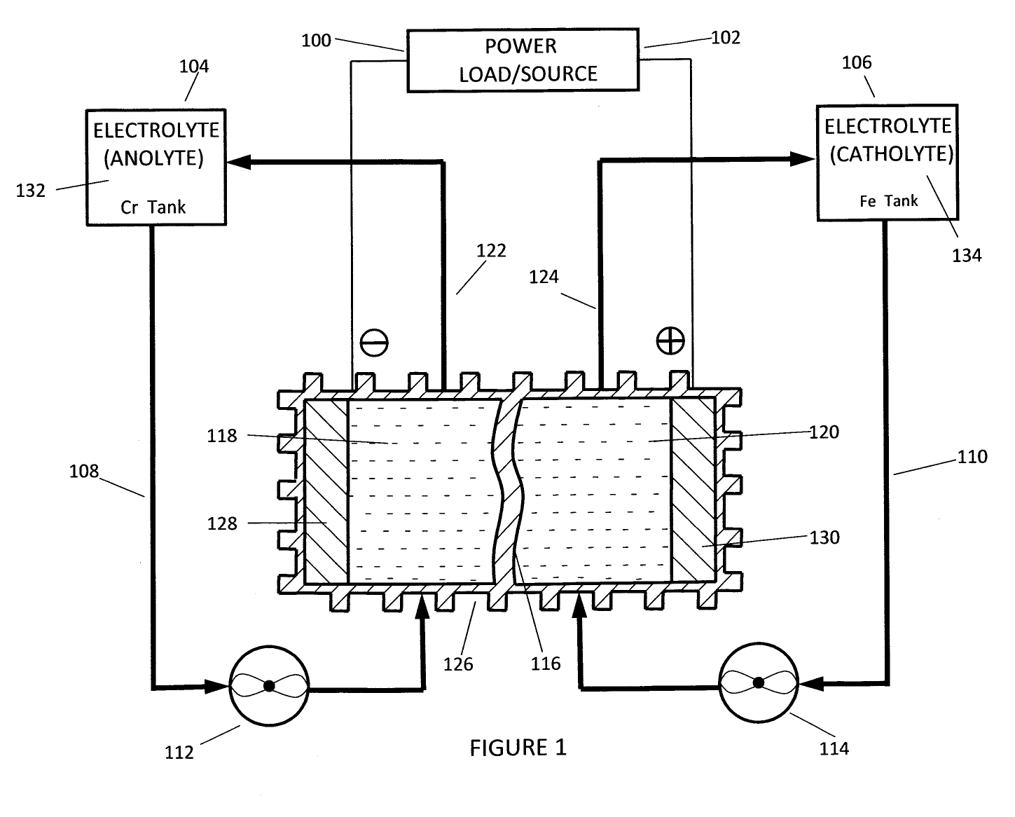

FIG. 1 illustrates an exemplary representation of a modular flow battery system 100 in which various embodiments of the invention may function. Modular flow battery system 100 includes, but is not limited to, a power load/source 102, an electrolyte chamber 104 containing electrolyte with positively charged ions 132, and electrolyte chamber 106 containing electrolyte with negatively charged ions 134, and at least one reactor-type flow cell 126. Multiple flow cells may be coupled (e.g., “stacked”) to form a multi-cell battery. Flow cell 126 includes two half-cells 118 and 120 separated by a membrane 116, through which ions are transferred during a redox reaction. Half-cell 118 contains an anolyte and half-cell 120 contains a catholyte, the anolyte and catholyte being collectively referred to as electrolytes. The electrolytes (i.e., anolyte and catholyte) are flowed through the half-cells 118 and 120, often with external pumping systems. In FIG. 1, pumping system 112 controls anolyte flow while pumping system 114 controls catholyte flow. At least one electrode 128 and 130 in each half cell provides a surface on which the redox reaction takes place and from which charge is transferred.

There are different electrolyte solutions which in turn contain differing dissolved electro-active chemicals. For example, in an exemplary embodiment of a redox system using electro-active chromium and ferrous chemicals, the anolyte may be comprised of an aqueous solution of hydrochloric acid and chromium chloride and the catholyte may be comprised of an aqueous solution of hydrochloric acid and iron chloride. In some other embodiments of the redox system using electro-active chromium and ferrous chemicals, both the anolyte and catholyte may be comprised of an aqueous solution of hydrochloric acid combined with chromium chloride and iron chloride.

The electro-chemical capacity of the electrolytes is a function of the amount of active material contained in the solution of the electrolytes and the oxidation state or charge of the electrolytes. The system is “in balance” when the anolyte and the catholyte have an equivalent amount of active material and charge. However, over time an electrochemical imbalance of the electrolytes may occur due to side reactions causing the system to become unbalanced due to differing charges between the anolyte and catholyte. Such imbalance reduces the output capacity of the battery. It is therefore desirable to maintain a balance of active material in the electrolyte solutions in order to maximize capacity and efficiency.

When electrolyte is flowed through a reactor cell an electrochemical reaction takes place in the reactor cell:

Cathodic reaction in half cell 120: Fe3+ +e-→Fe2+

Anodic reaction in half cell 118: Cr2+→Cr3+ +e-

In addition, a secondary reaction takes places where hydrogen gas (H₂) is emitted in an electrolysis reaction:

2HCL→H₂+2Cl⁻

The H₂ is emitted as gas and the Cl— is a scavenger. The H₂ and Cl must be recombined to maintain system balance.

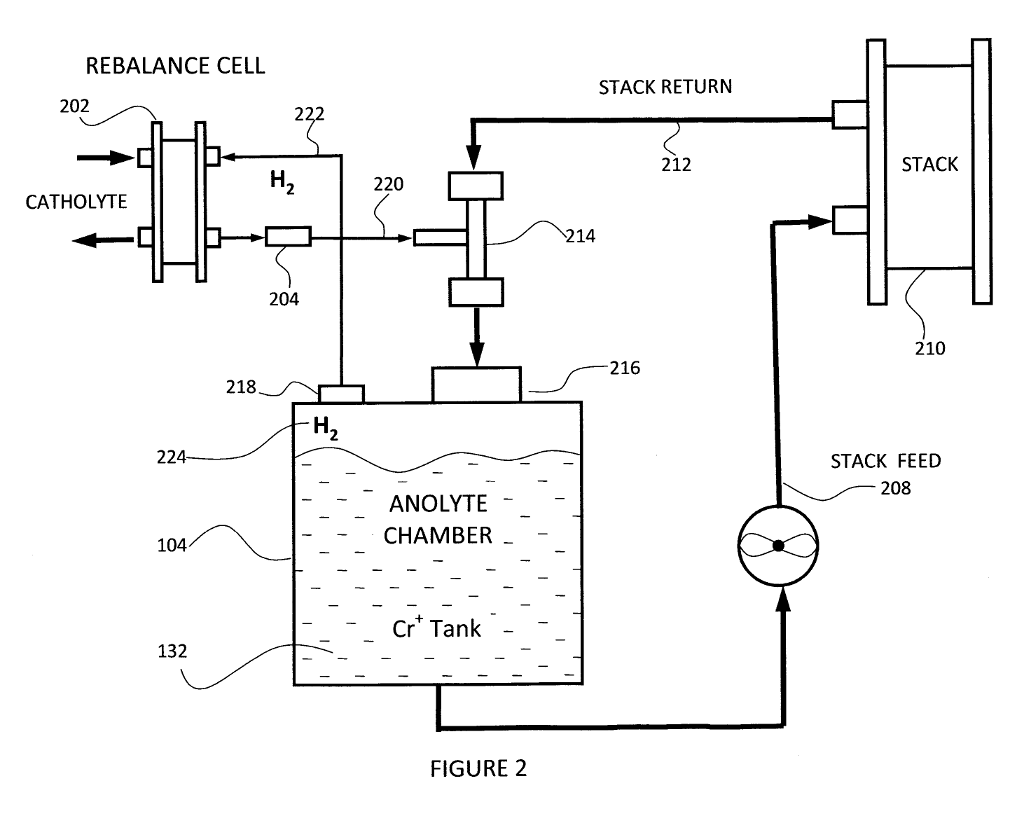

FIG. 2 illustrates the placement of rebalance cell 202 within a flow battery. Multiple rebalance cells can be stacked in much the same way that cells are stacked in a multi-cell battery. Hydrogen gas 224 from anolyte chamber 104 is pumped through rebalance cell 202 along with catholyte from the flow battery. Rebalance cell 202 can function to recombine hydrogen (H₂) with chlorine (2Cl⁻) or to consume the hydrogen as it is added to the catholyte, thus maintaining the electrochemical balance of the system.

The function of rebalance cell 202 may be significantly enhanced if the hydrogen gas is actively circulated as opposed to being “dead headed”. Under dead heading, the only driving force is partial pressure which results in very slow transfer of the hydrogen gas into rebalance cell 202. The use of normal gas pumps present problems in terms of both cost and reliability. One solution is to take advantage of the circulating electrolyte from anolyte chamber 104 to provide the driving force to circulate hydrogen gas 224 present at the top of anolyte chamber 206. The present invention provides that a venturi pump 214 may be coupled to electrolyte return pathway 212. Venturi pump 214 causes hydrogen gas (H₂) 224 to be drawn from H₂ tap 218 of electrolyte chamber 104 to produce an active flow of H₂ through rebalance cell 202. A check-valve 204 can be incorporated into H₂ return line 220 to prevent any backflow from entering the rebalance cell.

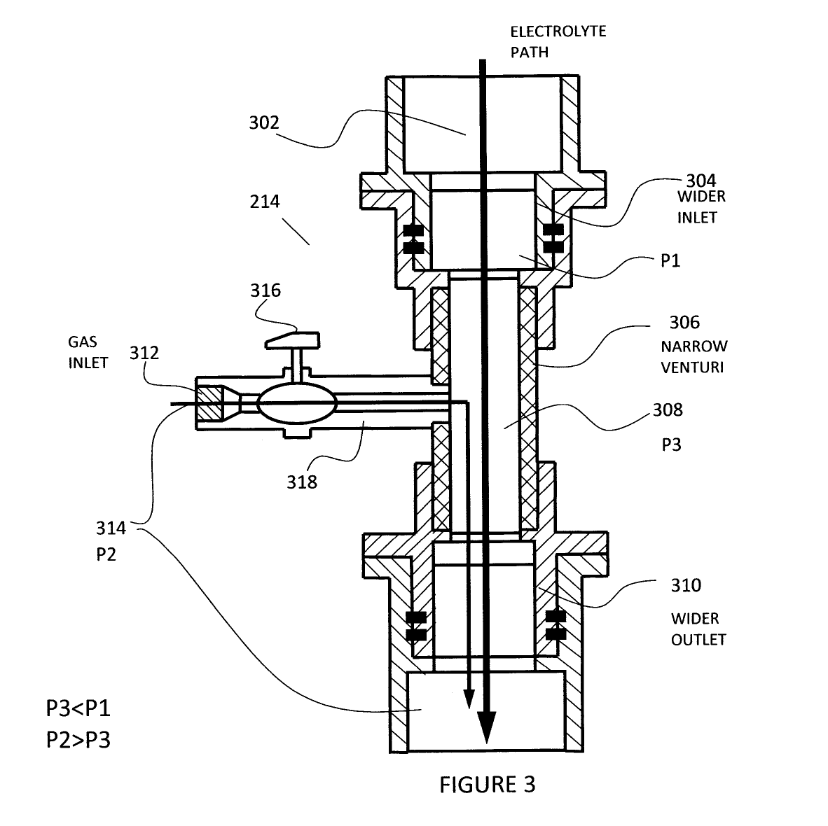

An embodiment of pump 214 is shown in FIG. 3. Pump 214 includes a slightly narrowed section of pipe 306. Due to the narrowing, the pressure drops in this section, in accordance with the Venturi effect. The pressure in the venturi also is below that of anolyte tank 104 which is the hydrogen source. A perpendicular small tube 318 penetrates this narrow venturi, and provides suction for hydrogen gas inlet 312. The hydrogen gas 224 that enters pump 214 is returned to anolyte chamber 104 where it again is taken up from H₂ tap 218, and re-circulated through rebalance cell 202. No moving parts are involved. A check-valve 204 is coupled to hydrogen inlet 312 to prevent electrolyte entering under low flow conditions. Pump 214 may be regulated by the addition of a metering valve 316 to regulate hydrogen flow. In some embodiments, metering valve 316 may be controlled remotely by an electronic control system.

While preferred embodiments of the present invention have been shown and described herein, it will be obvious to those skilled in the art that such embodiments are provided by way of example only. Numerous variations, changes, and substitutions will now occur to those skilled in the art without departing from the invention. As those of ordinary skill in the art will readily appreciate, for example, the present invention may circulate and recombine other gasses such as. It should be understood that various alternatives to the embodiments of the invention described herein may be employed in practicing the invention.

It is intended that the following claims define the scope of the invention and that methods and structures within the scope of these claims are their equivalents be covered thereby.

What is claimed is:

1. A flow system, comprising:
at least one flow cell;
a pumping system that pumps a first electrolyte from a first storage tank through a first half cell of the at least one flow cell;
a rebalance cell coupled to receive a second electrolyte from a second storage tank; and
a venturi pump in the pumping system, the venturi pump further coupled to receive a hydrogen gas that flows from the first storage tank and through the rebalance cell.

2. The flow system of claim 1, further comprising a check-valve coupled to a gas inlet of the venturi pump to limit or prevent backflow into the rebalance cell.

3. The flow system of claim 1, further comprising a metering valve coupled to a gas inlet of the venturi pump to regulate flow through the pump's gas inlet.

4. A method of circulating a hydrogen gas in a flow system, comprising:
flowing a first electrolyte via a pumping system from a first storage tank through a first half cell of at least one flow cell;
receiving a second electrolyte into a rebalance cell coupled to receive the second electrolyte; and
drawing the hydrogen gas from the first storage tank through the rebalance cell using a venturi pump coupled to the pumping system and further coupled to draw the hydrogen gas from the first storage tank through the rebalance cell.

5. The method of claim 4, further comprising:
limiting or preventing a backflow into the rebalance cell by coupling a check-valve to a gas inlet of the venturi pump.

6. The method of claim 4, further comprising:
regulating a flow through a gas inlet of the venturi pump by coupling a metering valve to the gas inlet.

7. A method of rebalancing a flow system, comprising:
flowing a first electrolyte via a pumping system from a first storage tank through a first half cell of at least one flow cell;
receiving a second electrolyte into a rebalance cell coupled to receive the second electrolyte; and
drawing a gas from the first storage tank through the rebalance cell using a venturi pump coupled to the pumping system and further coupled to draw the hydrogen gas from the first storage tank through the rebalance cell.

8. The method of claim 7, further comprising:
limiting or preventing a backflow into the rebalance cell by coupling a check-valve to a gas inlet of the venturi pump.

9. The method of claim 7, further comprising:
regulating a flow through a gas inlet of the venturi pump by coupling a metering valve to the gas inlet.
